(19) United States
(12) Patent Application Publication
(10) Pub. No.: US 2005/0283783 A1
(43) Pub. Date: Dec. 22, 2005

(54) Method for optimizing pipeline use in a multiprocessing system

(76) Inventor: Donald R. DeSota, Portland, OR (US)

Correspondence Address: LIEBERMAN & BRANDSDORFER, LLC, 802 STILL CREEK LANE, GAITHERSBURG, MD, 20878, US

(21) Appl. No.: 10/874,029

(22) Filed: Jun. 22, 2004

(51) Int. Cl. G06F 9/46

(52) U.S. Cl. 718/100

(57) ABSTRACT

A value tracking memory region within system memory is created to manage select locks and threads waiting for access to one or more of the select locks. When a thread requests access to an unavailable select lock, the thread will be stalled in the value tracking memory region. The stall process optimizes pipeline use by eliminating the process of a thread spinning on a lock, which utilizes pipeline resources.

### BACKGROUND OF THE INVENTION

1. Technical Field

This invention relates to a method and system for optimizing use of pipeline resources in a multiprocessing computer system using simultaneous multithreaded processors. More specifically, the invention relates to mitigating spinning on select locks in system memory.

2. Description of the Prior Art

Multiprocessor systems contain multiple processors (also referred to herein as CPUs) that can execute multiple processes or multiple threads within a single process simultaneously in a manner known as parallel computing. In general, multiprocessor systems execute multiple processes or threads faster than conventional single processor systems, such as personal computer, that execute programs sequentially. The actual performance advantage is a function of a number of factors, including the degree to which parts of a multithreaded process and/or multiple distinct processes can be executed in parallel and the architecture of the particular multiprocessor system. The degree to which processes can be executed in parallel depends, in part, on the extent to which they compete for exclusive access to shared memory resources.

Shared memory multiprocessor systems offer a common physical memory address space that all processors can access. Multiple processes therein, or multiple threads within a process, can communicate through shared variables in memory which allow the processes to read or write to the same memory location in the computer system. Message passing multiprocessor systems, in contrast to shared memory systems, have a separate memory space for each processor. They require processes to communicate through explicit messages to each other.

Pipelining is an implementation technique that exploits parallelism among instructions in a sequential instruction stream. Each stage in the pipeline completes a part of an instruction. Different stages complete different parts of different instructions in parallel. A pipeline in a multithreaded system has multiple stages. For example, in a pipeline configured to support two threads, some stages have resources for each of the two threads, while in other stages the resources are shared between threads. The width of the pipeline will determine how many operations it can support. The number of operations supported determines how many threads can be supported in a single stage. Execution flows from one pipeline stage to the next until the instructions reaches the end of the pipeline where it is retired. Subsequent stages in the pipeline can stall previous stages due to conflicts or resource issues. A stall for a given thread still allows other threads to utilize the pipeline. Optimizing use of the pipeline in a multithreaded processing system will improve operating efficiency.

In a single threaded pipeline, a stall of a thread execution stalls the pipeline, and the pipeline is unused until the stall condition is removed. Typical reasons for a stall may include operand dependencies, a cache miss, branch misprediction, etc. With simultaneous multithreading, multiple threads can be in the pipeline simultaneously. Some pipeline resources are private to a specific thread, such as registers, and some of the pipeline resources may be shared among threads, such as execution units, load/store units, and branch logic. In addition, some resources may be shared or be private depending upon implementation of the pipeline, such as translation look-aside buffer and cache resources. It is up to a pipeline dispatcher to determine which threads are stalled and to provide non-stalled threads access to shared resources in a pipeline stage. The dispatcher can use stall information from the pipeline to help schedule threads, thereby improving pipeline utilization.

A significant issue in the design of multiprocessor systems is process synchronization. The degree to which processes can be executed in parallel depends in part on the extent to which they compete for exclusive access to shared memory resources. For example, if two processes A and B are executing in parallel, process B might have to wait for process A to write a value to a buffer before process B can access it. Otherwise, a race condition could occur where process B might access the buffer while process A was part of the way through updating the buffer. Another example is if two processes want to use a system resource that must be accessed serially. To avoid conflicts, process synchronization mechanisms are provided to control the order of process execution. Such mechanisms include mutual exclusion locks, condition variables, counting semaphores, and reader-writer locks. A mutual exclusion lock allows only the processor holding the lock to execute an associated action. For example, when a processor wants to access a critical system resource it must first acquire a mutual exclusion lock before accessing the resource. When a mutual exclusion lock is acquired by a processor, it is granted to that processor exclusively. Other processors desiring the lock must wait until the processor with the lock releases it. Reader-writer locks are used to synchronize buffer access between processes. To address the buffer scenario described above, process A would place data in a buffer and then set the reader-writer lock. Process B would monitor the reader-writer lock to see if it is set. Once the lock is set, process B could then read the data from the buffer and clear the lock, and once the lock has been cleared by process B, process A is sent a signal to indicate the buffer is clear to be used for more data.

Examples of mutual exclusion locks include a spin lock and a queued lock. A spin lock is a construct that uses the cache coherence mechanism in a multiprocessor system to control access to a critical section. The lock provides for exclusive access to the critical code by a single processor in a multiprocessor system. The lock can have two values, either available or unavailable. The spin lock checks to determine if the lock is available by reading the value of the lock and testing the lock value to decide if the lock is available. If the lock is not available, the processor continues to spin on the check. However, if the lock is available, the processor then tries to acquire the lock through the execution of an atomic test and set instruction on the lock value. The atomic test and set instruction reads the value of the lock. If the lock is available, the atomic test and set instruction writes the value of the lock to unavailable. If the lock is unavailable, the atomic test and set instruction leaves the value of the lock unchanged. In addition, a flag is provided to indicate the availability of the lock. Following reading of the value of the lock, the flag is tested by the process that executed the atomic test and set instruction to determine if the lock was acquired. If the lock was not acquired, the processor returns to checking if the lock is available. However, if the lock was acquired, the processor executes the critical section of code and releases the lock by setting the value of the lock to available.

A queued lock is another form of a mutual exclusion lock in a multiprocessor system to control access to a critical section of code. The lock provides for exclusive access to critical code by a single processor in a multiprocessor system. A queued lock provides less write traffic over a spin lock since the test and set is eliminated, but requires more overhead for managing the queue. The lock can have two values, either available or unavailable. The processor checks to determine if the lock is available by reading the value of the lock and testing the lock value to decide if the lock is available. If the lock is not available, the processor continues to spin on the check. However, if the lock is available, the processor then checks to see if the processor is at the front of the queue. A processor which is at the front of the queue acquires the lock by setting the value of the lock to unavailable. The critical section of code is executed by the processor, and the head of the queue is updated and the lock is released by setting the value to available. If the processor is not at the head of the queue, it returns to spinning to see if the lock is available.

Similar to a spin lock, a barrier may be implemented in a multiprocessor system to synchronize processors running multiple threads in a multiprocessor system. The barrier is initially set to an integer value of the number of processors set to be synchronized less one. As each processor reaches the barrier, it decrements the count and then checks to see of the count is zero. If the count is not zero, the processor spins waiting for the count to get to zero. When the barrier integer is zero, this is an indication that all the processors have reached the barrier and that all processes are synchronized to the same point in program execution.

A spin on a lock is a two instruction sequence which uses valuable pipeline resources. Spinning while waiting to acquire a lock is not useful work from a program execution viewpoint. From the perspective of the pipeline dispatcher in a simultaneous multi-threaded processor, the spinning thread is not stalled because it is executing an instruction sequence. Therefore, the spinning thread will continue to dispatch the instructions in the spin. If the use of the resource by the spin function could be reduced or eliminated, these pipeline resources could be used by other threads that are not spinning on a lock. Accordingly, there is a need for reducing use of pipeline resources in a simultaneous multi-threaded processor system while threads spin on a lock.

### SUMMARY OF THE INVENTION

This invention comprises a method for improving operating efficiency of pipeline use in a multiprocessor system.

In one aspect of the invention, a method is provided for optimizing use of a pipeline. A select lock is placed within a region of system memory, wherein availability of the select lock is monitored. A thread requesting the select lock is stalled in the region of system memory when the select lock is unavailable.

In another aspect of the invention, a computer system with multiple processors is provided. A select lock is assigned to a region of system memory. In addition, a lock manager is provided to monitor availability of the select lock for a thread, and to stall the thread in the region of system memory in response to absence of availability of the select lock.

In yet another aspect of the invention, an article is provided with a computer-readable signal-bearing medium with multiple processors operating within the medium. Means in the medium are provided for monitoring availability of a select lock within a region of system memory. In addition, means in the medium are provided for stalling a thread requesting the select lock in the region of system memory when the lock is unavailable.

Other features and advantages of this invention will become apparent from the following detailed description of the presently preferred embodiment of the invention taken in conjunction with the accompanying drawings.

### BRIEF DESCRIPTION OF THE DRAWINGS

FIG. 1 is a block diagram of a multiprocessor system according to the preferred embodiment of this invention, and is suggested for printing on the first page of the issued patent.

FIG. 2 is a block diagram of the value tracking memory fields.

FIG. 3 is a flow chart illustrating a process of reading a lock value from the value tracking memory region.

FIG. 4 is a flow chart illustrating a processing of writing a lock value to the value tracking memory region.

### DESCRIPTION OF THE PREFERRED EMBODIMENT

### Overview

Creation of a value tracking memory region within system memory provides a select location within system memory to stall threads waiting for access to a select lock to execute an associated action. Each thread that spins on a lock uses pipeline resources that may otherwise be available in the simultaneous multithreaded processor. The process of stalling a thread makes pipeline resource available for other threads, while the thread requesting the lock waits in a designated region of system memory.

### Technical Details

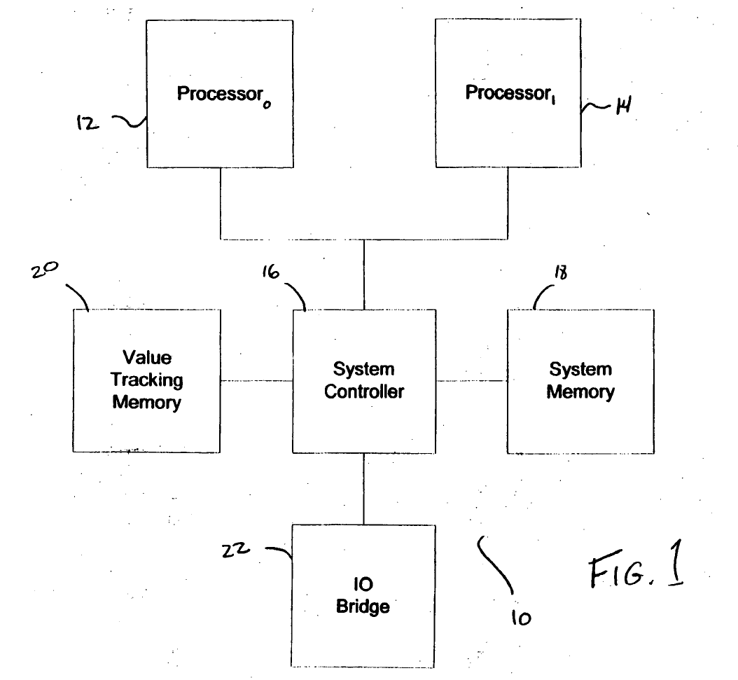

FIG. 1 is a block diagram (10) of a multiprocessor system according to one embodiment of the present invention. There are two processors (12) and (14), a system controller (16), system memory (18), value tracking memory region (20), and an I/O bridge (22). The system memory (18) is the central random access memory used to hold instructions and data. Memory mapped I/O is used to communicate with peripherals. Locks for accessing critical code are managed through system memory (18). The value tracking memory (20) is a region of the system memory (18) designed to monitor lock values for select locks. The system controller is configured to respond differently with respect to system memory references and value tracking memory references. In the preferred embodiment, all threads requesting a select lock are processed through the value tracking memory area of the system memory.

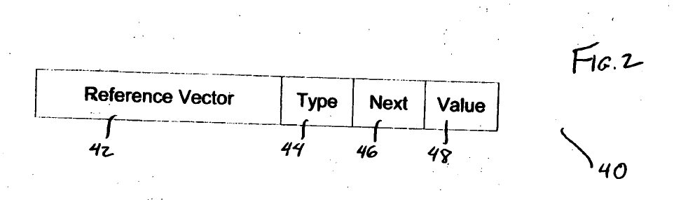

FIG. 2 is a block diagram (40) illustrating an example of the format according to the present invention for each entry in the value tracking memory region, wherein each entry represents a specific lock. In this example the following four fields are associated with each lock entry: reference vector field (42), type field (44), next field (46), and value field (48). The reference vector field (42) is used to track which threads have initially read the lock since it was made unavailable. Each bit in the reference vector field (42) field represents a thread that has accessed this entry. The type field (44) indicates the type of lock that is being requested. The next field (46) represents the next thread in a queued lock that will acquire the lock when it becomes available. The value field (48) is an integer value that holds the actual value of the lock. For example, in one embodiment if the lock is available the value field integer will be zero, and if the lock is unavailable the value field integer will be one. The value field is used by the system controller (16) to communicate availability of a lock to a thread. Accordingly, each entry in the value tracking memory represents a specific lock that is maintained in the value tracking memory region (20) of the system memory (18).

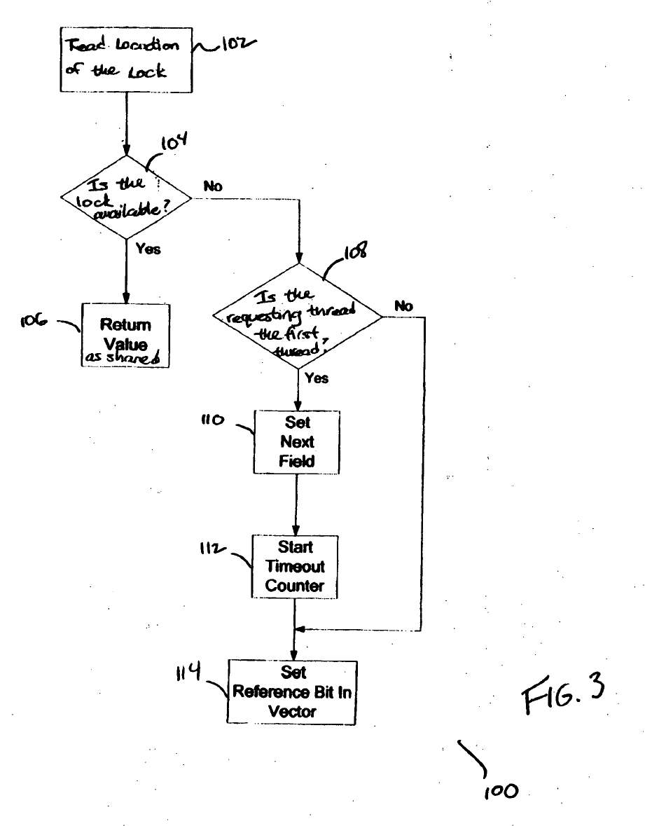

When a thread needs to acquire a lock that is managed by the value tracking memory region (20), the thread, i.e. requesting thread, will initiate the acquisition process by reading the value of the lock. FIG. 3 is a flow chart (100) illustrating the process of a thread reading a lock value from the value tracking memory region of system memory. The thread initiates reading a lock value by reading the location of the lock to determine if the lock is available (102). Thereafter, a test is conducted to determine if the lock is available (104). In one embodiment of the present invention, a lock value of zero is indicative of availability of the lock. Furthermore, in another embodiment of the system controller conducts the test of availability of the lock. A positive response to the test at step (104) is an indication that the lock is available to the thread, and the value of the lock is returned with a state of shared to the requesting thread (106). The value of the lock is returned as shared so subsequent updates to the value are visible to the system controller. However, a negative response to the test at step (104) is an indication that the lock is not available to the thread. A subsequent test is conducted to determine if the requesting thread is the first thread to request the lock since it has become unavailable (108). In the case of a queued lock, this step will determine the order of the queuing of threads. A positive response to the test at step (108) is an indication that the requesting thread is the next thread for a queued lock. The system controller will set the next field in the value tracking memory fields for the specified lock to the requesting thread (110). In addition, a timeout counter may be initiated to limit the amount of the a thread may wait for the requested lock to become available (112). In one embodiment, the system controller initiates the timeout counter. Following step (112) or if at step (108), it is determined that the requesting thread is not the first thread to request the lock since the lock has become unavailable, the system controller sets the appropriate bit associated in the reference vector field for the thread requesting the select lock (114). The lock will not be returned to the requesting thread until the value field of the lock entry is written to available by the thread that has acquired the lock. This process causes the requesting thread of the requesting processor to stall the thread requesting the lock in the value tracking memory region until a writing thread releases the requested lock. The process of stalling a requesting thread prevents the thread from using pipeline cycles which occurs when a waiting thread spins on an unavailable lock. In the case of a timeout counter, a thread is only permitted to stall for a predefined quantity of time, after which the lock value is returned to the stalled thread causing the thread to initiate another reading of the lock value of a requested lock. Accordingly, the thread requesting an unavailable lock that is managed in the value tracking memory region of system memory is forced to stall in the value tracking memory region of system memory until such time as the writing thread releases the lock.

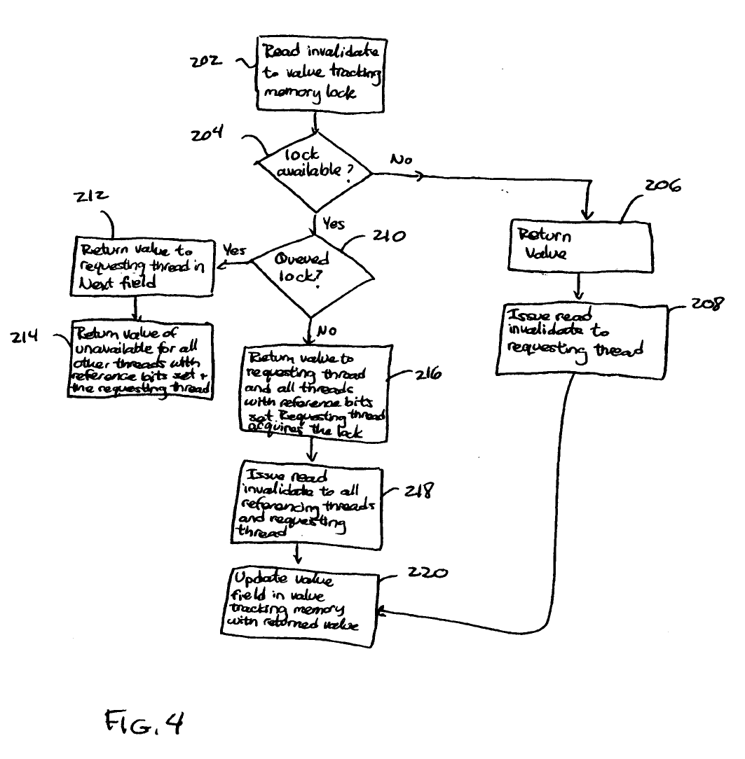

Complimentary to the reading of a lock value shown in FIG. 3, a thread in possession of a lock, i.e. a requesting thread, may need to update the value of the lock in the value tracking memory region of system memory. FIG. 4 is a flow chart (200) illustrating the process of writing an update value of the lock. The first step in this process is for the thread to issue a read invalidate for the value tracking memory lock (202). The read invalidate procedure enables the thread in possession of the lock to read an exclusive copy of the lock value into the cache and to update the lock value. The system controller receives the read invalidate command for the value tracking memory lock. Following the update to the lock value, the system controller forces all threads to update their cache. Thereafter, a test is conducted to determine if the lock is available subsequent to the read invalidate procedure (204). In one embodiment, the system controller conducts the test at step (204). A negative response to the test is an indication that the lock was not made available, i.e. not released, during the read invalidate procedure. In one embodiment, a lock value of zero indicates the lock is available, and a lock value of one indicates the lock is unavailable. The value of the lock is returned to the thread that issued the read invalidate (206), followed by issuance of a read invalidate to the requesting thread to clear the lock value from the thread's cache (208). This will cause the thread to re-read the lock value allowing the value tracking memory to stall the thread, as opposed to enabling the thread to spin on the lock. When data is returned from the read invalidate at step (208), the value field (48) in value tracking memory is updated with the value returned from the read invalidate (220). However, a positive response to the test at step (204) is an indication that the lock is now available. A subsequent test is conducted to determine if the lock that was made available at step (202) is a queued lock (210). If the lock is a queued lock, the value of the lock is returned to the requesting thread that is identified in the next field of the value tracking memory (212). The remainder of the threads with reference bits set to wait for the queued lock and the requesting thread will be notified that the lock is not available (214). In one embodiment, a value of one indicating that the queued lock is not available could be returned to the remainder of the threads. The step of returning an unavailable value to the waiting threads in the queue lifts the stall that was implemented at steps (110) and (112). However, if the lock is not a queued lock, a message is sent to the requesting thread and all stalled threads with a reference bit set for this specific type of lock indicating the lock is now available to be acquired, and the requesting thread will acquire the lock (216). In one embodiment, a value of zero is returned to all stalled threads with a reference bit set for this specific type of lock to indicate the lock is now available to be acquired. Each of the threads with the reference bit set for the lock and the requesting thread will try to acquire the lock or to proceed past the barrier.

When the message that the lock is now available, for example a lock value of zero, has been returned, is communicated to all of the waiting threads indicating the lock is available, the stall on the threads is lifted. The thread which initiated the read invalidate at step (202) will acquire the lock. All other threads that had a reference bit set for the lock that did not acquire the lock will reissue a read on the lock. Once the lock has been acquired by the requesting thread, the system controller will issue a read invalidate to all referencing threads and the requesting thread to clear the entry from the cache (218). When data is returned from the read invalidate at step (218), the value field (48) in value tracking memory is updated with the value returned from the read invalidate (220). In one embodiment, the lock value could be set to one indicating that the lock is not available. Accordingly, the process of changing the value of a specific lock entry to available removes the stall placed on the threads that have a reference bit set for the lock, and allows waiting threads to acquire the lock.

### Advantages Over the Prior Art

It is known in the art for waiting threads to spin on an otherwise unavailable lock. In the prior art, every spin cycle is a two instruction sequence which uses pipeline resources that may otherwise be available for other threads. Placement of select locks in a specified region of system memory allows the threads requesting the select locks to stall in the specified region of memory. Although there is overhead involved with having a thread stall and wait for the lock in the specified region of memory, the process of stalling a thread does not issue any instruction into the pipeline. Accordingly, the process of stalling a waiting thread in a specified region of system memory enables other threads in a simultaneous multithreaded processor to utilize pipeline resources, instead of having the pipeline resource used for a thread spinning on the unavailable lock.

### Alternative Embodiments

It will be appreciated that, although specific embodiments of the invention have been described herein for purposes of illustration, various modifications may be made without departing from the spirit and scope of the invention. In particular, the locks have been identified as a spin lock, a queued lock, or a barrier lock. However, the select locks placed in the value tracking memory region may include other lock types depending upon the needs of the system, and more specifically the operating needs of the pipeline and the affects on the pipeline of the threads spinning on alternative lock types. Accordingly, the scope of protection of this invention is limited only by the following claims and their equivalents.

1. A method for optimizing pipeline use in a multiprocessing system, comprising:
placing a select lock in a region of system memory;
monitoring availability of said select lock; and
stalling a thread requesting said select lock in said region in response to unavailability of said lock.

2. The method of claim 1, wherein the step of stalling a thread requesting said select lock includes a failure to return lock data until said select lock is available.

3. The method of claim 1, wherein the step of stalling a thread requesting said select lock includes setting a bit in a reference field associated with said lock.

4. The method of claim 1, further comprising lifting a stall of a thread on said select lock in response to availability of said select lock.

5. The method of claim 4, wherein the step of lifting a stall of a thread includes returning data to all threads with a reference bit set for said select lock in said region.

6. The method of claim 1, wherein said select lock is selected from a group consisting of: a spin lock, a queued lock, and a barrier lock.

7. A computer system, comprising:
multiple processing units;
a select lock assigned to a region of system memory; and
a lock manager adapted to monitor availability of the lock for a thread,
wherein said manager is adapted to stall said thread in said region of system memory in response to absence of availability of said select lock.

8. The system of claim 7, wherein said lock manager prevents a return of lock data to said thread until said select lock is available.

9. The system of claim 7, wherein said lock manager is adapted to set a bit in a reference field associated with said lock.

10. The system of claim 7, wherein said lock manager is adapted to remove a stall of a thread on said select lock in response to availability of said select lock.

11. The system of claim 10, wherein said lock manager is adapted to return data to all threads with a reference bit set for said select lock in said region.

12. The system of claim 7, wherein said select lock is selected from a group consisting of: a spin lock, a queued lock, and a barrier lock.

13. The system of claim 7, wherein said processing units are simultaneous multithreaded processors.

14. An article comprising:
a computer-readable signal-bearing medium;
means in the medium for monitoring availability of a select lock within a region of system memory; and
means in the medium for stalling a thread requesting said select lock in said region of system memory when said lock is unavailable.

15. The article of claim 14, wherein the medium is selected from a group consisting of a recordable data storage medium, and a modulated carrier signal.

16. The article of claim 14, wherein said means in the medium for stalling a thread requesting said unavailable lock includes means for setting a bit in a reference field associated with said lock.

17. The article of claim 14, further comprising means in the medium for lifting a stall of a thread on said select lock in response to availability of said lock.

18. The article of claim 17, wherein said means for lifting a stall of a thread includes returning data to all thread with a reference bit set for said select lock in said region.

19. The article of claim 14, wherein said lock is selected from a group consisting of a spin lock, a queued lock, and a barrier lock.

20. A method for optimizing pipeline use in a multiprocessor system, comprising:
monitoring availability of a select lock, and
stalling a thread requesting said lock in a region of system memory in response to unavailability of said lock, wherein the step of stalling a thread requesting said select lock includes a failure to return lock data until said lock is available.
